(19) United States
(12) Patent Application Publication
(10) Pub. No.: US 2011/0183659 A1
(43) Pub. Date: Jul. 28, 2011

(54) COMMUNITY GROUP CLIENT AND COMMUNITY AUTO DISCOVERY SOLUTIONS IN A WIRELESS COMMUNICATIONS NETWORK

(75) Inventors: Ravi Ayyasamy, Richardson, TX (US); Bruce D. Lawler, Kirkwood, CA (US); Brahmananda R. Vempati, Dallas, TX (US); Gorachand Kundu, Karnataka (IN); Krishnakant M. Patel, Richardson, TX (US)

(73) Assignee: KODIAK NETWORKS, INC., San Ramon, CA (US)

(21) Appl. No.: 12/961,419

(22) Filed: Dec. 6, 2010

Related U.S. Application Data
(60) Provisional application No. 61/266,896, filed on Dec. 4, 2009.

(51) Int. Cl. H04M 3/00

(52) U.S. Cl. 455/419

(57) ABSTRACT

A Community Group Client and Community Auto-Discovery for use in a wireless communications network. The Community Group Client and Community Auto-Discovery are used with Community Group features for Advanced Voice Services or Advanced Group Services in wireless communications systems.

### CROSS REFERENCE TO RELATED APPLICATIONS

This application claims the benefit under 35 U.S.C. Section 119(e) of the following co-pending and commonly-assigned patent application:

U.S. Provisional Application Ser. No. 61/266,896, filed Dec. 4, 2009, by Ravi Ayyasamy, Bruce D. Lawler, Bujji Vempati, and Gorachand Kundu, entitled “COMMUNITY GROUP CLIENT AND COMMUNITY AUTO DISCOVERY SOLUTIONS,” attorneys' docket number 154.40-US-P1;

which application is incorporated by reference herein.

This application is related to the following co-pending and commonly-assigned patent applications:

U.S. Utility application Ser. No. 10/515,556, filed Nov. 23, 2004, by Gorachand Kundu, Ravi Ayyasamy and Krishnakant Patel, entitled “DISPATCH SERVICE ARCHITECTURE FRAMEWORK,” attorney docket number G&C 154.4-US-WO, now U.S. Pat. No. 7,787,896, issued Aug. 31, 2010, which application claims the benefit under 35 U.S.C. Section 365 of P.C.T. International Application Serial Number PCT/US03/16386 (154.4-WO-U1), which application claims the benefit under 35 U.S.C. Section 119(e) of U.S. Provisional Application Ser. Nos. 60/382,981 (154.3-US-P1), 60/383,179 (154.4-US-P1) and 60/407,168 (154.5-US-P1);

U.S. Utility application Ser. No. 10/564,903, filed Jan. 17, 2006, by F. Craig Farrill, Bruce D. Lawler and Krishnakant M. Patel, entitled “PREMIUM VOICE SERVICES FOR WIRELESS COMMUNICATIONS SYSTEMS,” attorney docket number G&C 154.7-US-WO, now U.S. Publication No. 2006/0189337, which application claims the benefit under 35 U.S.C. Section 365 of P.C.T. International Application Serial Number PCT/US04/23038 (154.7-WO-U1), which application claims the benefit under 35 U.S.C. Section 119(e) of U.S. Provisional Application Ser. Nos. 60/488,638 (154.7-US-P1), 60/492,650 (154.8-US-P1) and 60/576,094 (154.14-US-P1) and which application is a continuation-in-part and claims the benefit under 35 U.S.C. Sections 119, 120 and/or 365 of P.C.T. International Application Serial Number PCT/US03/16386 (154.4-WO-U1);

U.S. patent application Ser. No. 11/126,587, filed May 11, 2005, by Ravi Ayyasamy and Krishnakant M. Patel, entitled “ARCHITECTURE, CLIENT SPECIFICATION AND APPLICATION PROGRAMMING INTERFACE (API) FOR SUPPORTING ADVANCED VOICE SERVICES (AVS) INCLUDING PUSH TO TALK ON WIRELESS HANDSETS AND NETWORKS,” attorney docket number 154.9-US-U1, now U.S. Pat. No. 7,738,892, issued Jun. 15, 2010, which application claims the benefit under 35 U.S.C. Section 119(e) of U.S. Provisional Application Ser. Nos. 60/569,953 (154.9-US-P1) and 60/579,309 (154.15-US-P1), and which application is a continuation-in-part and claims the benefit under 35 U.S.C. Sections 119, 120 and/or 365 of U.S. Utility application Ser. No. 10/515,556 (154.4-US-WO) and P.C.T. International Application Serial Number PCT/US04/23038 (154.7-WO-U1);

U.S. Utility application Ser. No. 11/129,268, filed May 13, 2005, by Krishnakant M. Patel, Gorachand Kundu, Ravi Ayyasamy and Basem Ardah, entitled “ROAMING GATEWAY FOR SUPPORT OF ADVANCED VOICE SERVICES WHILE ROAMING IN WIRELESS COMMUNICATIONS SYSTEMS,” attorney docket number 154.10-US-U1, now U.S. Pat. No. 7,403,775, issued Jul. 22, 2008, which application claims the benefit under 35 U.S.C. Section 119(e) of U.S. Provisional Application Ser. No. 60/571,075 (154.10-US-P1), and which application is a continuation-in-part and claims the benefit under 35 U.S.C. Sections 119, 120 and/or 365 of U.S. Utility application Ser. No. 10/515,556 (154.4-US-WO) and P.C.T. International Application Serial Number PCT/US04/23038 (154.7-WO-U1);

U.S. Utility application Ser. No. 11/134,883, filed May 23, 2005, by Krishnakant Patel, Vyankatesh V. Shanbhag, Ravi Ayyasamy, Stephen R. Horton and Shan-Jen Chiou, entitled “ADVANCED VOICE SERVICES ARCHITECTURE FRAMEWORK,” attorney docket number 154.11-US-U1, now U.S. Pat. No. 7,764,950, issued Jul. 27, 2010, which application claims the benefit under 35 U.S.C. Section 119(e) of U.S. Provisional Application Ser. Nos. 60/573,059 (154.11-US-P1) and 60/576,092 (154.12-US-P1), and which application is a continuation-in-part and claims the benefit under 35 U.S.C. Sections 119, 120 and/or 365 of U.S. Utility application Ser. No. 10/515,556 (154.4-US-WO), P.C.T. International Application Serial Number PCT/US04/23038 (154.7-WO-U1), U.S. Utility application Ser. No. 11/126,587 (154.9-US-U1), and U.S. Utility application Ser. No. 11/129,268 (154.10-US-U1);

U.S. Utility application Ser. No. 11/136,233, filed May 24, 2005, by Krishnakant M. Patel, Vyankatesh Vasant Shanbhag, and Anand Narayanan, entitled “SUBSCRIBER IDENTITY MODULE (SIM) ENABLING ADVANCED VOICE SERVICES (AVS) INCLUDING PUSH-TO-TALK, PUSH-TO-CONFERENCE AND PUSH-TO-MESSAGE ON WIRELESS HANDSETS AND NETWORKS,” attorney docket number 154.13-US-U1, now U.S. Pat. No. 7,738,896, issued Jun. 15, 2010, which application claims the benefit under 35 U.S.C. Section 119(e) of U.S. Provisional Application Ser. No. 60/573,780 (154.13-US-P1), and which application is a continuation-in-part and claims the benefit under 35 U.S.C. Sections 119, 120 and/or 365 of U.S. Utility application Ser. No. 10/515,556 (154.4-US-WO), P.C.T. International Application Serial Number PCT/US04/23038 (154.7-WO-U1), U.S. Utility application Ser. No. 11/126,587 (154.9-US-U1), and U.S. Utility application Ser. No. 11/134,883 (154.11-US-U1);

U.S. Utility application Ser. No. 11/158,527, filed Jun. 22, 2005, by F. Craig Farrill, entitled “PRESS-TO-CONNECT FOR WIRELESS COMMUNICATIONS SYSTEMS,” attorney docket number 154.16-US-U1, now U.S. Pat. No. 7,529,557, issued May 5, 2009, which application claims the benefit under 35 U.S.C. Section 119(e) of U.S. Provisional Application Ser. No. 60/581,954 (154.16-US-P1), and which application is a continuation-in-part and claims the benefit under 35 U.S.C. Sections 119, 120 and/or 365 of U.S. Utility application Ser. No. 10/515,556 (154.4-US-WO) and P.C.T. International Application Serial Number PCT/US04/23038 (154.7-WO-U1);

U.S. Utility application Ser. No. 11/183,516, filed Jul. 18, 2005, by Deepankar Biswaas, entitled “VIRTUAL PUSH TO TALK (PTT) AND PUSH TO SHARE (PTS) FOR WIRELESS COMMUNICATIONS SYSTEMS,” attorney docket number 154.17-US-U1, now U.S. Publication No. 2006/0030347, which application claims the benefit under 35 U.S.C. Section 119(e) of U.S. Provisional Application Ser. No. 60/588,464 (154.17-US-P1);

U.S. Utility application Ser. No. 11/356,775, filed Feb. 17, 2006, by Krishnakant M. Patel, Bruce D. Lawler, Giridhar K. Boray, and Brahmananda R. Vempati, entitled “ENHANCED FEATURES IN AN ADVANCED VOICE SERVICES (AVS) FRAMEWORK FOR WIRELESS COMMUNICATIONS SYSTEMS,” attorney docket number 154.18-US-U1, now U.S. Pat. No. 7,813,722, issued Oct. 12, 2010, which application claims the benefit under 35 U.S.C. Section 119(e) of U.S. Provisional Application Ser. No. 60/654,271(154.18-US-P1);

P.C.T. International Application Serial Number PCT/US2006/011628, filed Mar. 30, 2006, by Krishnakant M. Patel, Gorachand Kundu, Sameer Dharangaonkar, Giridhar K. Boray, and Deepankar Biswas, entitled “TECHNIQUE FOR IMPLEMENTING ADVANCED VOICE SERVICES USING AN UNSTRUCTURED SUPPLEMENTARY SERVICE DATA (USSD) INTERFACE,” attorney docket number 154.19-WO-U1, now PCT Publication No. WO06105287, which application claims the benefit under 35 U.S.C. Section 119(e) of U.S. Provisional Application Ser. No. 60/666,424 (154.19-US-P1);

U.S. Utility application Ser. No. 11/462,332, filed Aug. 3, 2006, by Deepankar Biswas, Krishnakant M. Patel, Giridhar K. Boray, and Gorachand Kundu, entitled “ARCHITECTURE AND IMPLEMENTATION OF CLOSED USER GROUP AND LIMITING MOBILITY IN WIRELESS NETWORKS,” attorney docket number 154.20-US-U1, now U.S. Pat. No. 7,689,238, issued Mar. 30, 2010, which application claims the benefit under 35 U.S.C. Section 119(e) of U.S. Provisional Application Ser. No. 60/705,115 (154.20-US-P1);

U.S. Utility application Ser. No. 11/463,186, filed Aug. 8, 2006, by Ravi Ayyasamy and Krishnakant M. Patel, entitled “ADVANCED VOICE SERVICES CLIENT FOR BREW PLATFORM,” attorney docket number 154.21-US-U1, now U.S. Publication No. 2007/0037598, which application claims the benefit under 35 U.S.C. Section 119(e) of U.S. Provisional Application Ser. No. 60/706,265 (154.21-US-P1);

U.S. Utility application Ser. No. 11/567,098, filed Dec. 5, 2006, by Ravi Ayyasamy, Bruce D. Lawler, Krishnakant M. Patel, Vyankatesh V. Shanbhag, Brahmananda R. Vempati, and Ravi Shankar Kumar, entitled “INSTANT MESSAGING INTERWORKING IN AN ADVANCED VOICE SERVICES (AVS) FRAMEWORK FOR WIRELESS COMMUNICATIONS SYSTEMS,” attorney docket number 154.23-US-U1, now U.S. Publication No. 2007/0190984, which application claims the benefit under 35 U.S.C. Section 119(e) of U.S. Provisional Application Ser. No. 60/742,250 (154.23-US-P1);

U.S. Utility application Ser. No. 11/740,805, filed Apr. 26, 2007, by Krishnakant M. Patel, Giridhar K. Boray, Ravi Ayyasamy, and Gorachand Kundu, entitled “ADVANCED FEATURES ON A REAL-TIME EXCHANGE SYSTEM,” attorney docket number 154.26-US-U1, now U.S. Publication No. 2007/0253347, which application claims the benefit under 35 U.S.C. Section 119(e) of U.S. Provisional Application Ser. No. 60/795,090 (154.26-US-P1);

U.S. Utility application Ser. No. 11/891,127, filed Aug. 9, 2007, by Krishnakant M. Patel, Deepankar Biswas, Sameer P. Dharangaonkar and Terakanambi Nanjanayaka Raja, entitled “EMERGENCY GROUP CALLING ACROSS MULTIPLE WIRELESS NETWORKS,” attorney docket number 154.27-US-U1, now U.S. Publication No. 2008/0064364, which application claims the benefit under 35 U.S.C. Section 119(e) of U.S. Provisional Application Ser. No. 60/836,521 (154.27-US-P1);

U.S. Utility application Ser. No. 12/259,102, filed Oct. 27, 2008, by Krishnakant M. Patel, Bruce Lawler, Gorachand Kundu, Ravi Ayyasamy, Ravi Shankar Kumar, Harisha Mahabaleshwara Negalaguli, Basem Ahmad Ardah, Prathap Chandana, Shan-Jen Chiou, Arun Velayudhan, and Ramu Kandula, entitled “CONNECTED PORTFOLIO SERVICES FOR A WIRELESS COMMUNICATIONS NETWORK,” attorneys' docket number 154.32-US-U1, now U.S. Publication No. 2009/0149167, which application claims the benefit under 35 U.S.C. Section 119(e) of U.S. Provisional Application Ser. No. 60/982,650 (154.32-US-P1) and U.S. Provisional Application Serial Number 61/023,042 (154.32-US-P2);

U.S. Utility application Ser. No. 12/359,861, filed Jan. 26, 2009, by Bruce D. Lawler, Krishnakant M. Patel, Ravi Ayyasamy, Harisha Mahabaleshwara Negalaguli, Binu Kaiparambil, Shiva Cheedella, Brahmananda R. Vempati, Ravi Shankar Kumar, and Avrind Shanbhag, entitled “CONVERGED MOBILE-WEB COMMUNICATIONS SOLUTION,” attorney docket number 154.33-US-U1, now U.S. Publication No. 2009/0209235, which application claims the benefit under 35 U.S.C. Section 119(e) of U.S. Provisional Application Ser. No. 61/023,332 (154.33-US-P1);

U.S. Utility application Ser. No. 12/582,601, filed Oct. 20, 2009, by Krishnakant M. Patel, Ravi Ayyasamy, Gorachand Kundu, Basem A. Ardah, Anand Narayanan, Brahmananda R. Vempati, and Pratap Chandana, entitled “HYBRID PUSH-TO-TALK FOR MOBILE PHONE NETWORKS,” attorney docket number 154.36-US-U1, now U.S. Publication No. 2010/0142414, which application claims the benefit under 35 U.S.C. Section 119(e) of U.S. Provisional Application Ser. No. 61/106,689 (154.36-US-P1);

U.S. Utility application Ser. No. 12/781,566, filed May 17, 2010, by Bruce D. Lawler, Krishnakant M. Patel, Ravi Ayyasamy, Harisha Mahabaleshwara Negalaguli, Binu Kaiparambil, Shiva Koteshwara Kiran Cheedella, Brahmananda R. Vempati, and Ravi Shankar Kumar, entitled “CONVERGED MOBILE-WEB COMMUNICATIONS SOLUTION,” attorney docket number 154.38-US-Il, now U.S. Publication No. 2010/0234018, which application claims the benefit under 35 U.S.C. Section 120 (e) of U.S. Utility application Ser. No. 12/359,861 (154.33-US-U1), which application claims the benefit under 35 U.S.C. Section 119(e) of U.S. Provisional Application Ser. No. 61/023,332 (154.33-US-P1); and

U.S. Utility application Ser. No. 12/750,175, filed Mar. 30, 2010, by Bruce D. Lawler, Krishnakant M. Patel, Ravi Ayyasamy, Harisha Mahabaleshwara Negalaguli, Basem A. Ardah, Gorachand Kundu, Ramu Kandula, Brahmananda R. Vempati, Ravi S. Kumar, Chetan M. Patel, and Shiva Koteshwara Kiran Cheedella, entitled “ENHANCED GROUP CALLING FEATURES FOR CONNECTED PORTFOLIO SERVICES IN A WIRELESS COMMUNICATIONS NETWORK,” attorneys' docket number 154.39-US-U1, which application claims the benefit under 35 U.S.C. Section 119(e) of U.S. Provisional Application Ser. No. 61/164,754 (154.39-US-P1) and U.S. Provisional Application Ser. No. 61/172,129 (154.39-US-P2);

all of which applications are incorporated by reference herein.

### BACKGROUND OF THE INVENTION

1. Field of the Invention

This invention relates in general to wireless communications systems, and more specifically, to a community group client and community auto-discovery solutions in a wireless communications network.

2. Description of Related Art

Advanced Group Services (AGS), also known as Advanced Voice Services (AVS), can include a number of different functions, such as Push-to-Conference (P2C) or Instant Conferencing, etc., as described in the co-pending and commonly-assigned patent applications cross-referenced above and incorporated by reference herein. These AGS functions have enormous revenue earnings potential for wireless communications systems, such as mobile phone networks.

Currently, there are three major approaches employed in providing AGS in wireless communications systems. One approach requires the installation of a dedicated private network, parallel to the wireless communications system, to support the group-based voice services. However, a dedicated private network is costly to install and maintain.

Another approach is based on Voice over IP (VoIP) technologies. While this approach promises compliance with newer and emerging standards, such as GPRS (General Packet Radio Service), UMTS (Universal Mobile Telecommunications System), etc., it does not provide a solution for carriers employing wireless communications systems based on existing standards, such as GSM, CDMA, etc. However, even for the newer standards, solutions based on VoIP have serious drawbacks, including slower call setup, significant overhead, increased susceptibility to packet losses, low bit rate voice coders, and significant modifications to the mobile handset.

Still another approach is the innovative approach described in the co-pending and commonly-assigned patent applications cross-referenced above and incorporated by reference herein. In this approach, advanced voice services are provided by a real-time exchange (RTX), also known as a dispatch gateway (DG), that interfaces to the wireless communications system to provide the advanced voice services therein, wherein both the real-time exchange and mobiles that use the advanced voice services communicate with each other using call setup and in-band signaling within the wireless communications system.

However, notwithstanding the innovations described in the co-pending and commonly-assigned patent applications cross-referenced above, there is a need in the art for improvements to the AGS, as well as the AVS, that comply with existing and emerging wireless standards and provide superior user experiences. The present invention aims to satisfy this need by providing a Community Group Client and Community Auto-Discovery solution in a wireless communications network.

### SUMMARY OF THE INVENTION

To overcome the limitations in the prior art described above, and to overcome other limitations that will become apparent upon reading and understanding the present specification, the present invention a community group client and community auto-discovery solutions in a wireless communications network. These and other aspects of the present invention are described in more detail below.

### BRIEF DESCRIPTION OF THE DRAWINGS

Referring now to the drawings in which like reference numbers represent corresponding parts throughout:

FIG. 1 is a block diagram that illustrates an exemplary embodiment of a wireless communications network, according to a preferred embodiment of the present invention.

FIG. 2 illustrates a proposed architecture for the RTX, according to the preferred embodiment of the present invention.

FIG. 3 illustrates the high-level functional components and their interfaces in a handset, according to a preferred embodiment of the present invention.

### DETAILED DESCRIPTION OF THE INVENTION

In the following description of the preferred embodiment, reference is made to the accompanying drawings which form a part hereof, and in which is shown by way of illustration the specific embodiment in which the invention may be practiced. It is to be understood that other embodiments may be utilized as structural changes may be made without departing from the scope of the present invention.

Overview

The present invention discloses a Community Group Client and Community Auto-Discovery in a wireless communications network. The Community Group Client and Community Auto-Discovery are used with Community Group features for AGS in wireless communications systems, which are described in more detail herein.

More specifically, the Community Group features include, but are not limited to, the following:

1. Application Store Downloads,

2. Group Communications Subscriptions,

3. Friends and Family,

4. Family Member Modification,

5. Ad Hoc Group Creation for Calling and Messaging,

6. Synchronization of Contact List with Phone,

7. Client Group Management,

8. Community Discovery,

9. Ad Hoc Quick Reach,

10. Community Lookup and Friends and Family Display,

11. Threaded Group Messaging,

12. Threading and Playback of Group Voice SMS,

13. Picture/Video Message Sending,

14. Sending Location Information from the Client,

15. Chat Instant Messaging,

16. Chat Picture. Video and Audio Messaging,

17. Chat Location Messaging, and

18. Community Auto Discovery Solution.

More information on these Community Group features is provided below.

System Description

Overview

The following illustration explains the network reference architecture used to provide the Community Group features for the AGS described herein. These Community Group features are provided without any changes to the existing network infrastructure, but merely the addition of a service control point, known as a Real-Time Exchange (RTX), connected to the network and a Community Group Client application embedded in a handset.

Network Architecture

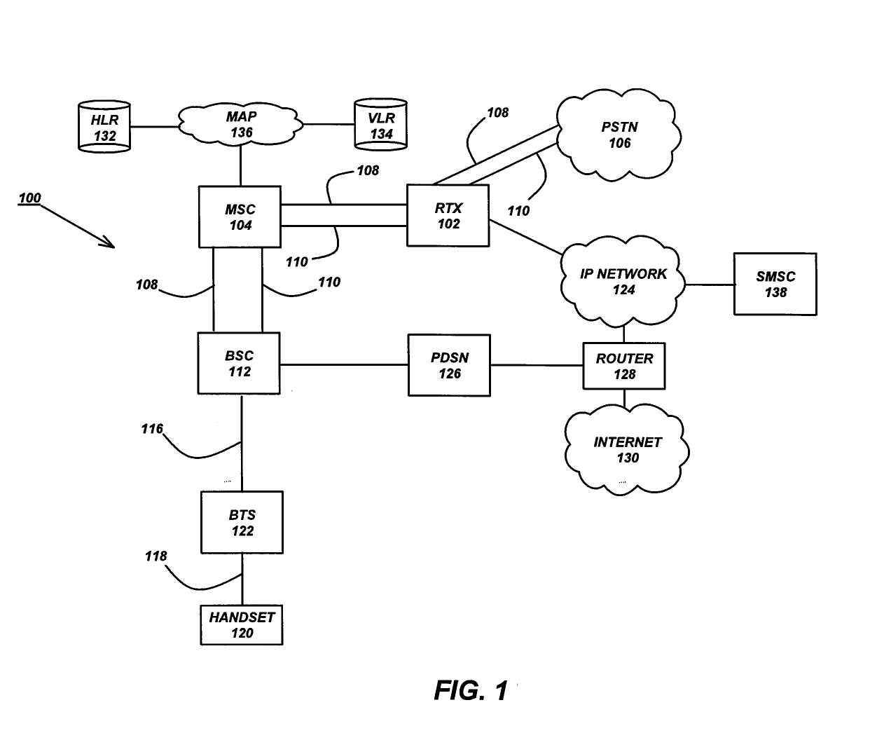

FIG. 1 is a block diagram that illustrates an exemplary embodiment of a wireless communications network according to a preferred embodiment of the present invention.

Within the network 100, an RTX 102, also known as a Dispatch Gateway (DG), communicates with a MSC (Mobile Switching Center) 104 and PSTN (Public Switched Telephone Network) 106 using SS7-ISUP/WIN/CAMEL (Signaling System 7-Integrated Services Digital Network User Part/Wireless Intelligent Network/Customized Applications for Mobile Enhanced Logic) messages at a signaling plane 108. A bearer path 110 implements a TDM (Time Division Multiplexing) interface carrying PCM (Pulse Code Modulation) or TFO (Tandem Free Operation) voice frames. Support for TFO in this path 110 is negotiated between a BSC (Base Station Controller) 112 and the RTX 102 for each originating and terminating leg of an AGS call. The use of TFO ensures high voice quality (as voice vocoder conversion is avoided) between mobile-to-mobile calls.

When a subscriber originates an AGS call, the MSC 104 routes the call to the RTX 102. The MSC 104 also requests the BSC 112 via 116 to establish a radio traffic path 118 with a handset 120, which is also known as a mobile station (MS) or mobile unit, via the BTS (Base Transceiver Station) 122 (as it does for a normal cellular call). At this time, the BSC 112 tries to negotiate TFO (if it is supported) on a TDM link with the far end (in this case, the RTX 102).

At the same time (after the MSC 104 terminates the group call request to the RTX 102), the RTX 102 identifies the terminating group users and their numbers, which may comprise an MS-ISDN (Mobile Station-Integrated Services Digital Network) number, an IMSI (International Mobile Subscriber Identity) number, or an MDN (Mobile Directory Number).

The RTX 102 sends an ISUP call origination request for each terminating handset 120. It may send requests directly to the MSC 104, PSTN 106 or IP network 124 via a PDSN (Public Data Switched Network) 126, Router 128, and/or Internet/Intranet 130, depending on the routing table configuration for terminating numbers. Once the bearer path 110 is established, the RTX 102 begins a negotiation with the far end (in this case, the terminating BSC 112) for each terminating leg to a handset 120.

Once bearer paths 110 are established for originating and terminating legs for an AGS call, the RTX 102 switches (or duplicates) voice or data from the originating handset 120 to all terminating handsets 120.

The RTX 102 may also use an IP network 124 or the Internet/Intranet 130. In one embodiment, the IP network 124 or the Internet/Intranet 130 can be used in place of the normal cellular telephone system signaling, e.g., in place of SS7.

In addition, the IP network 124 or the Internet/Intranet 130 can be used in a toll bypass mode where two RTXs 102 can exchange voice traffic bypassing the PSTN 106. However, each RTX 102 is responsible for terminating traffic to its closest MSC 104. In this case, the IP network 124 or the Internet/Intranet 130 is used as a backbone transport of voice traffic between two RTXs 102.

The IP network 124 or the Internet/Intranet 130 can also be used for a registration and presence application. Since the MSC 104 will not direct a registration request from a handset 120 to the RTX 102 (because it would require changes in the MSC 104), the latter does not have any information of the registered handset 120. To circumvent this issue, a registration and presence application runs over an IP stack in the handset 120. After the handset 120 registers for a data interface (i.e., obtaining an IP address) with the PDSN 126 (or Serving GSM Service Nodes (SGSN) in the case of GSM networks), the registration and presence application in the handset 120 registers with the RTX 102 using its IP address. The RTX 102 also uses this IP interface to update the presence information of other group members to a handset 120.

An alternative embodiment may use the SMS (Short Message Service) transport to carry presence messages over a data channel. The RTX 102 interacts with the handset 120 using predefined presence application related messages that are transported as SMS messages. The same messages can be transported via the PDSN 126 interface, if group users have data service.

During roaming, a Home Location Register (HLR) 132 and Visitor Location Register (VLR) 134 can be accessed via the MSC 104 and a MAP link 136. The HLR 132 and VLR 134 are used to track the mobile handsets 120 within home or foreign networks, while the RTX 102 is used to track the presence of members of a group within the home or foreign networks and updates the mobile handsets 120 for those members with the network availability of other members of the group.

A Short Message Service Center (SMSC) 138 is accessible via the IP network 124 (or other element) for the storage of text messages (SMS messages). When an SMS message is sent to a handset 120, the message is first stored in the SMSC 138 until the recipient handset 120 is available (e.g., a store-and-forward option).

Real Time Exchange

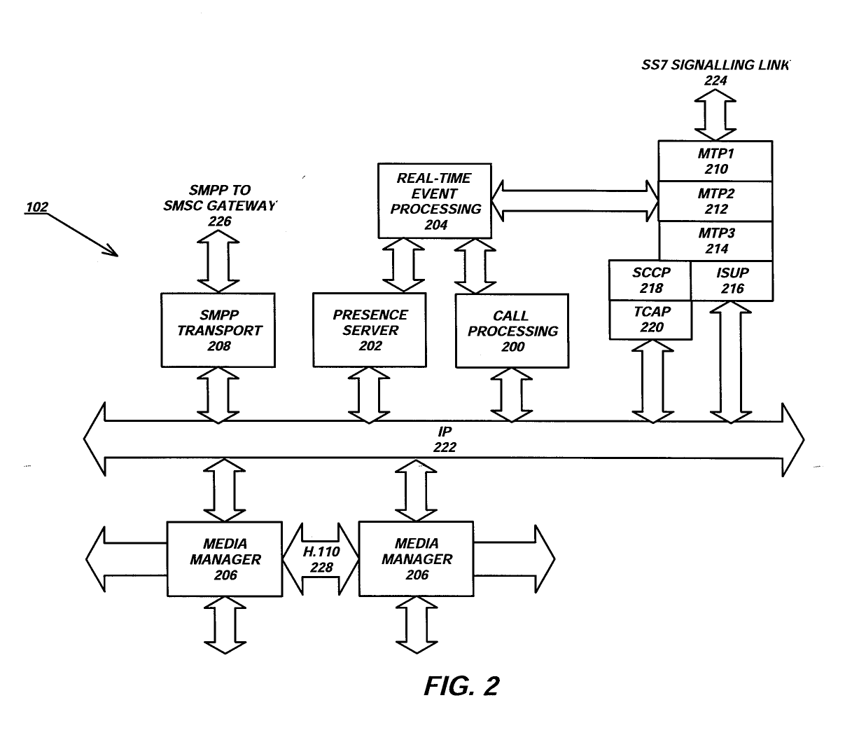

FIG. 2 illustrates a proposed architecture for the RTX 102 according to the preferred embodiment of the present invention.

The architecture includes a Call Processing system 200, Presence Server 202, Real-Time Event Processing system 204, one or more Media Managers 206, and an SMPP (Short Message Peer-to-Peer) Transport 208, as well as modules for various SS7 protocols, such as MTP-1 (Message Transfer Part Level 1) 210, MTP-2 (Message Transfer Part Level 2) 212, MTP-3 (Message Transfer Part Level 3) 214, ISUP (Integrated Services Digital Network User Part) 216, SCCP (Signaling Connection Control Part) 218, and TCAP (Transactions Capabilities Application Part) 220 protocols.

The Call Processing system 200, Presence Server 202, Media Managers 204, SMPP Transport 206, and other modules communicate across an IP network 222. The Real-Time Event Processing system 204 communicates directly with the Call Processing system 200, Presence Server 202, and the modules for various SS7 protocols. The modules for various SS7 protocols communicate with other entities via a SS7 Signaling Link 224. The SMPP Transport 206 communicates with a SMSC (Short Message Service Center) gateway using the SMPP protocol 226. The Media Managers 204 communicate among themselves using the H.110 protocol 228 (or some other protocol, such TCP/IP).

The operation of these various components are described in more detail below, as well as in the co-pending and commonly-assigned patent applications cross-referenced above and incorporated by reference herein.

The originating handset 120 signals the RTX 102 via the wireless network 100, e.g., by transmitting one or more messages to the RTX 102. The Media Manager systems 206 receive the messages and pass the messages to the Call Processing system 200. The Call Processing (CP) system 200 determines whether the originating handset 120 has subscribed to the AGS before originating the AGS call. Upon confirmation, the Call Processing system 200 initiates a new AGS call. The Call Processing system 200 interacts with the Presence Server 202 and Real-Time Event Processing system 204 to cause the wireless network 100 to perform call setup with the terminating handsets 120 for the AGS call, and thereafter to manage the AGS call.

During the AGS call, the Call Processing system 200 interacts with the Media Manager systems 206 to maintain the H.110 channels 227 and assign any additional H.110 channels 228 required for the AGS call, which may span across multiple Media Manager systems 206. During the AGS call, the Media Manager systems 206 of the RTX 102 are used to mix audio streams between the originating handset 120 and the terminating handset 120, and then deliver these mixed audio streams to the originating handset 120 and the terminating handset 120. The H.110 channels 228 are used for passing mixed and unmixed audio streams voice between the Media Manager systems 200 as required.

Mobile Station Components

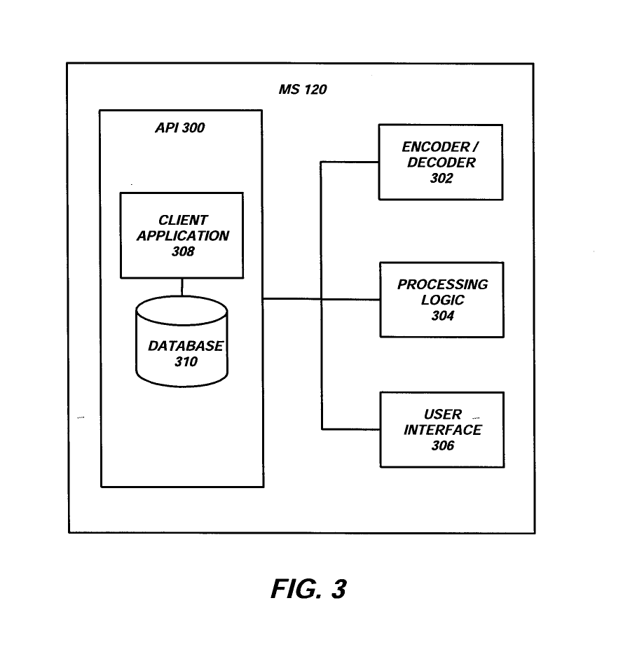

FIG. 3 illustrates the high-level functional components and their interfaces in the handset 120 according to a preferred embodiment of the present invention. In one embodiment, the software architecture used in the handset 120 is based on an Open OS implementation and is available under multiple operating systems, including JAVA, WINDOWS MOBILE, SYMBIAN and BREW.

Preferably, the software architecture used in the handset 120 provides an application programming interface (API) that supports the logic and data required within the handset 120 for providing cellular service, including the functions necessary for the making an AGS call generally, for providing the Community Group features for AGS calls.

The high-level functional components of the handset 120 include a subscriber identity module (SIM) 300, encoder/decoder 302, processing logic 304 and user interface 306. A Community Group Client application 308 is provided on the SIM 300 that supports AGS functionality for the handset 120. In addition, the SIM 300 stores a database 310, which includes an address book, AGS contacts and/or group information.

At power-on, the handset 120 loads the Community Group Client application 308 necessary to support the AGS. This functionality provided includes the “look and feel” of the menu displays on the handset 120, as well as user interaction with the menu displays.

During operation, the encoder/decoder 302 decodes and encodes messages, and populates specific data structures in the handset 120. The encoder/decoder 302 checks the validity of the incoming messages by verifying mandatory parameters for each of the incoming messages. A message will not be processed further if the encoder/decoder 302 fails to decode the message.

The processing logic 304 handles all the AGS related functionalities. The processing logic 304 implementation is device-specific and vendor-specific, and it interacts with the other components, including the encoder/decoder 302, user interface 306, client application 308 and database 310.

The processing logic 304 provides an auto-answer mechanism for AGS calls. Specifically, when a call is received, the processing logic 304 automatically answers the call. The processing logic 304 makes use of call notification for incoming call detection and, based on various parameters received within the call notification, determines whether the call is an AGS call. If the call is an AGS call, then the processing logic 304 uses “AT” commands to answer the AGS call and turn on the speaker of the handset 120. (All of this takes place within a certain time period.) On the other hand, if the call is not an AGS call, then normal call processing is performed by the handset 120.

The processing logic 304 also provides “floor control” using DTMF tone control. For example, in push-to-talk (P2T) calls, which are half-duplex, a determination of who may talk is based on who has the “floor.” Using the processing logic 304 provided in the handset 120, appropriate DTMF tones are sent to the RTX 102 in accordance with specific key sequences (i.e., pressing and/or releasing a P2T key) that indicate whether the “floor” has been requested and/or released by the user.

In addition, the processing logic 304 provides SMS destination control based on the type of subscriber. At the time of subscriber data provisioning, if it is determined that the handset 120 will use AGS based logic, then appropriate logic is invoked in the RTX 102 to send presence messages over SMS to the handset 120. Similarly, the handset 120 is configured at the time of provisioning to receive/accept such SMS and respond to the RTX 102 appropriately.

Finally, the processing logic 304 also enables subscribers to track the presence of fellow members of the group in the network 100 on their handset 120, and provides a mechanism and API to carry-out contacts and group management operations on the handset 120, such as add member, delete member, etc.

Since most of the presence information is stored in the database 310, the database 310 is tightly integrated with the processing logic 304. The database 310 stores groups, contacts, presence and availability related information. The database 310 information essentially contains group and member information along with presence information associated with each group and member. Apart from group and member information, the database 310 also stores subscriber information, such as privileges, presence information, etc. The other components of the handset 120 may interact with the database 310 to retrieve/update the group, members and presence information for various operations. The database 310 also has pointers to the native address book on the handset 120, to provide seamless “alias” naming for contacts used with cellular calls, as well as AGS.

The user interface 306 provides a mechanism for the user to view and manage groups, group members, contacts, presence and availability. The user interface 306 also makes it possible to invoke the AGS from the group/contact list screens, as described in more detail below.

Group Communications Client

As noted above, the RTX 102 and handset 120 work together to provide the functionality of the Community Group features for AGS calls in wireless communications network 100. The specifics of this functionality are described in more detail in the following sections.

In one embodiment, the Community Group client application 308 provides a number of self-service features.
Foremost among this is that the Community Group Client application 308 can be downloaded into the handset 120 from an online application store. However, alternative embodiments will have the Community Group Client application 308 embedded in the handset 120 at the time of purchase.
Another self-service feature is the ability to manage the subscriber's group communications subscription using the Community Group Client application 308.
Still another self-service feature is the ability to manage the subscriber's “friends and family” plan using the Community Group Client application 308. This includes functions related to member management and member identification.

In one embodiment, the Community Group Client application 308 provides a number of group management features, including the ability to:
Create and edit groups on the Community Group Client application 308.
Import existing groups from the RTX 102, if the subscriber previously a Group Communications subscriber.
Create ad hoc groups on the Community Group Client application 308.
Modify family members (e.g., show family group, change non-plan member, and enable or disable family members on the Community Group Client application 308.

In one embodiment, the Community Group Client application 308 provides a number of Quick Reach management features, wherein the Quick Reach service is a call originating service that allows a user to create a list of phone numbers in order to reach a particular person, so that when the user originates this type of call, all the phones for that particular person are called and rang until one of the phones answers the call, and then the rest of call attempts are dropped. The Community Group Client application 308 provides the ability to:
Create and edit numbers on the Community Group Client application 308.
Create ad hoc Quick Reach groups.

In one embodiment, the Community Group Client application 308 performs a number of foundation functions, including the ability to:
Synchronization of the contact list with the handset 120.
Community identification.
Presence (on/off) indication for subscribers on the handset 120.
Threaded group messaging.

Using these various features and functions, the Community Group Client application 308 provides an enhanced user experience, including the ability to:
Initiate group calls and messages from the Community Group Client application 308.
Initiate Quick Reach calls and messages from the Community Group Client application 308.
Group picture and/or video message sending.
Group based location sending.

These and other aspects of the Community Group Client application 308 are described in more detail below.

Application Store Downloadable

Subscribers are able to log into an application store from their handset 120, download the Community Group Client application 308 to their handset 120, load it on their handset 120, and activate various group services. This feature makes it easier for network 100 operators to distribute the Community Group Client application 308, which increases the rate of adoption of the service. This feature also reduces the need for network 100 operators' customer service to interact with subscribers for download instructions.

Group Communications Subscription

This feature allows a user to easily sign-up for Group Communications directly from their handset 120. Users can download the Community Group Client application 308 from the application store, view the interface, and then opt in for service. As a result, this provides an additional avenue for subscription (e.g., Web, WAP, or Client). This ability to download the Community Group Client application 308 and activate the service reduces the likelihood that customers will contact network 100 operators' customer service directly to inquire about how to purchase on-line.

Friends and Family

The Community Group Client application 308 allows for easy management of a user's “Friends and Family” subscription. Specifically, the user's “Friends and Family” subscription is supported within the Community Group Client application 308 as an item on a “carousel” displayed on the handset 120, which allows users to view current “Friends and Family” members, and add and remove “Friends and Family” members.

Family Member Modification

The Community Group Client application 308 displays both the Group Communications Family or Account Connect Group. The Group Communications Family/Account Connect group shows up under a separate menu. This allows users to see who is in their family group and from that screen launch calls or messages to the group.

The Community Group Client application 308 also displays a screen for Family Member modification. One modification that can be performed is to change a non-plan member, which allows the group owner to add or remove non Family/Account Connect group members to the Family/Account Connect group. Another modification that can be performed is to enable or disable, which allows the account owner to add the Group Communications feature for other Family/Account Connect Subscribers in his family group.

Ad Hoc Group Creation for Calling and Messaging

The Community Group Client application 308 can perform an ad hoc group creation for calling and messaging, which provides the following functions:
One-touch dialing using the native phonebook of the handset 120, which eliminates the need for a bridge, or a PIN, or an access code, etc.
Group call to multiple numbers (e.g., 30 numbers) on any network 100 using any phone.
The Community Group Client application 308 supports mid-call participant add/drop.
Mobile attendees can easily re-join if dropped via a single click from an automatic SMS notification of the conference.
Built-in support for mid-call add and drop.

Synchronization of Contact List with Phone

The Community Group Client application 308 synchronizes with the native phonebook of the handset 120. Specifically, the Community Group Client application 308 automatically imports the contact list (names and phone numbers) from the handset 120 every time a users logs into the Community Group Client application 308. Moreover, any changes made on the web to contacts or groups in the handset 120 are imported to the Community Group Client application 308 and then shared with the native phonebook on the handset 120.

In addition, the Community Group Client application 308 can export groups into the native phone book of the handset 120. Thus, any groups created in the Community Group Client application 308 are exported directly into the native phone book of the handset 120, giving the subscriber a seamless group creation experience.

Client Group Management Features

The Community Group Client application 308 performs a synchronization of existing groups from the RTX 102 for Group Communications subscribers. This means that the Community Group Client application 308 imports existing groups from the RTX 102, if the user was previously a Group Communications subscriber. This eliminates group redundancies for groups that contain multiple Group Communications subscribers.

The Community Group Client application 308 also allows the user to create and edit groups on the handset 120. Subscribers can create groups and later edit them (remove and add members) through the Community Group Client application 308. This eliminates the need for the user to go to the web to create or edit groups.

The Community Group Client application 308 allows the user to initiate Group calls and Group messages from the Community Group Client application 308. Users have the ability to launch group calls or messages directly from the Community Group Client application 308. The benefit from this feature is a better user experience, as the subscriber will not have to exit the Community Group Client application 308 once groups are created.

Community Auto-Discovery

In order to increase usage of community based services, such as PTT, Group Calling, etc., it is be useful to provide existing subscribers with information on other subscribers who are in the native phone book of the handset 120.

Ad Hoc Quick Reach

The Community Group Client application 308 can perform an ad hoc Quick Reach function on the handset 120. This allows users to create and edit Quick Reach groups on the Community Group Client application 308. The creation of a Quick Reach group works the same way an ad hoc group works, i.e., contacts are selected from the contact list through the Community Group Client application 308. This function increases the value of the Community Group Client application 308 and enhances the features to end users.

Community Lookup and Friends and Family Display

The Community Group Client application 308 performs both a Community and “Friends and Family” identification for the user.

The Community identification allows subscribers to visually identify all other subscribers in their contact list. The Community Group Client application 308 automatically synchronizes the user's contact list with other subscribers and provides that information in real-time to the user. The Community identification list will refresh on the Community Group Client application 308 every time the user logs into the Community Group Client application 308.

The “Friends and Family” identification allows subscribers to visually locate their selected “Friends and Family” contacts. The Community Group Client application 308 allows users to edit their “Friends and Family” contact list and updates the associated icons on login and refresh. These features allow subscribers to know, via displayed icons, which contacts are subscribers to the same network 100 (i.e., for mobile-to-mobile calling) and which contacts are members of the “Friends and Family” service.

The Community Group Client application 308 also performs a Presence (on/off) indication for subscribers. This feature provides presence information for all subscribers in the contact list that also have the Community Group Client application 308. There is a viral appeal to this feature, in that the more contacts a users has, that also have the Community Group Client application 308, the more valuable the presence feature.

Specifically, the following functions are performed by the Community Group Client application 308:
Presence indicates contacts status.
Groups can be built, called and sent text.
Group Messaging allows users to text and reply-to-all.
Voice Messaging allows users to send individual or group voice messages.

The Community Group Client application 308 automatically looks up which contacts in the native phone book of the handset 120 are members of the user's “Friends and Family” and the overall subscriber community (i.e., subscribers to the same network 100) and indicates that status with special icons on the handset 120.

Threaded Group Messaging

The Community Group Client application 308 provides for threaded group messaging. This allows users to see message threading of conversations with individuals and groups. The Community Group Client application 308 provides a consolidated SMS/MMS inbox, showing 1-to-1 or Many-to-Many communications and specialized icons. The effect is to provide users an IM (Instant Messaging) type of experience with both individuals and groups. Moreover, the threaded group messaging is integrated with the Community Group Client application 308 in such a manner that all group and voice messages can be seen threaded together, which allows users to keep track of complete conversations.

Threading and Playback of Group Voice SMS

The Community Group Client application 308 provides for threaded voice messaging. This allows users to see message threading of voice messages to groups. Moreover, group voice messages can be seen threaded together, which allows user to keep track of complete conversations. The Community Group Client application 308 also provides for reply-to-sender and reply-to-all functions, which are embedded within the Community Group Client application 308 and accessible directly from the voice message itself.

Picture/Video Message Sending

Subscribers have the ability to send pictures and video to individuals or groups from the Community Group Client application 308. Files are accessed from native file directory on the handset 120 and sent via SMS to the recipient and/or group.

For example, a user may send a message to a group, and attach a video stored on the handset 120 to the message. At the receiving Community Group Client application 308, the message is shown in the conversations and threads of that group, and the video may be downloaded to the Community Group Client application 308 for viewing. On handsets 120 that receive video messages in their in-box, the video message is displayed according native support on the handset 120.

Sending Location Information from the Client

The Community Group Client application 308 allows subscribers to send a map of their location from a browser on the handset 120. Maps are accessed via web based map services.

For example, a user may send a message to a group, and can add his current location to the message from an options menu. At the receiving Community Group Client application 308, the location is displayed on a map. On handsets 120 that receive the message in their in-box, the location is sent as a link to a map displayed on the browser on the handset 120.

The Community Group Client application 308 also allows subscribers to send a map of any location from the browser on the handset 120. Again, maps are accessed via web based map services.

For example, a user may send a message to a group, and can add a location to the message by navigating through a map displayed on the browser on the handset 120 or by searching for a location. At the receiving Community Group Client application 308, the location is displayed on a map. On handsets 120 that receive the message in their in-box, the location is sent as a link to a map displayed on the browser on the handset 120.

Chat Service

The Community Group Client application 308 provides various “Chat” functionalities to subscribers.

It is envisioned that subscribers will pay an additional fee or a different rate plan to communicate via Chat with subscribers in their contact list. For example, there may be discounted, or limited, or unlimited, full-duplex calling and Instant Messaging (IM) among Chat members and groups in the contact list. Calls may be preceded by a tone to indicate different type of service and rate. IM may only be available with other Chat members and groups. The Community Group Client application 308 provides support for Voice IM, Picture/Video IM and Location IM.

It is also envisioned that every Chat member will pay a fee to communicate, so that both parties share the cost, and not just the calling party pays. However, there is also potential for regional pricing plans, as well as both post-paid and pre-paid plans, and calling party plans.

In one embodiment, the Community Group Client application 308 provides the following “Chat” functions:
A “presence” icon or identifier indicates the contact's status.
Groups can be created or edited.
Group calling allows users to instantly call multiple people on any network 100.

1:1 calling allows users to instantly call anyone in the Chat contact list (and possibly where calls from the Community Group Client application 308 offer reduced pricing).
IM allows users to Instant Message with individuals and groups.
A separate contact list is maintained containing only Chat members that user may call or IM.

Chat Instant Messaging

The Community Group Client application 308 provides the following “Chat” IM functions:
Threaded conversations, which provide context and allow quick back and forth communications.
Multi-modal messages, wherein text, voice, music, pictures, and video messages can be included in threads.
Group conversation threading, wherein messages among all group members are included in one thread to allow convenient communications among groups.
IP-based Chat, which provides cost-effective messaging for Chat members.
Dynamic menus, which provide the ability to add additional multi-media message types (voice, music, picture, video) for an additional fee.

Chat Picture. Video and Audio Messaging

Subscribers have the ability to send pictures, videos or audio to individuals or groups from the Community Group Client application 308 during a “Chat” session. Files are accessed from native file directory on the handset 120 and sent via SMS to the recipients and/or group.

For example, a user may send a message to a group, and attach pictures, videos or audio stored on the handset 120 to the message. At the receiving Community Group Client application 308, the message is shown in the conversations and threads of that group, and the pictures, videos or audio may be downloaded to the Community Group Client application 308 for presentation. On handsets 120 that receive the pictures, videos or audio messages in their in-box, the pictures, videos or audio is presented according native support on the handset 120.

Chat Location Messaging

Subscribers have the ability to send location information to individuals or groups from the Community Group Client application 308 during a “Chat” session. The Community Group Client application 308 allows subscribers to send a map of their location from a browser on the handset 120. Maps are accessed via web based map services.

For example, a user may send a message to a group, and can add his current location to the message from an options menu. At the receiving Community Group Client application 308, the location is displayed on a map. On handsets 120 that receive the message in their in-box, the location is sent as a link to a map displayed on a browser on the handset 120.

The Community Group Client application 308 also allows subscribers to send a map of any location from a browser on the handset 120. Again, maps are accessed via web based map services.

For example, a user may send a message to a group, and can add a location to the message by navigating through a map displayed on a browser on the handset 120 or by searching for a location. At the receiving Community Group Client application 308, the location is displayed on a map. On handsets 120 that receive the message in their in-box, the location is sent as a link to a map displayed on a browser on the handset 120.

Community Auto Discovery Solution

In order to increase usage of Community Group features such as PTT, conferencing, etc., it is desirable to provide tools to users to enhance their community.

The Community Auto Discovery solution provides a method for users to expand their community and provides a means to identify members who subscribe to Community Group features and who are already in the phone book of a user's handset 120 (and hence already known to the user). Community Auto Discovery allows users to effectively communicate with other community members whom they already know. Community Auto Discovery is also advantageous to network 100 operators as it results in increased usage of the service (and hence higher revenue potential)

Once a user subscribes to a Community Group service, downloads the Community Group Client application 308 into their handset 120, the phone book in the handset 120 is copied into the contact list of the Community Group Client application 308. This contact list is then transmitted to the RTX 102 via a standard communication link/protocol such as SyncML, SMS, etc. A software routine in the RTX 102 then determines whether anyone in the contact list subscribes to one or more Community Group services; if so, a message is returned to the Community Group Client application 308 indicating those subscribers.

The RTX 102 also sends an “Application Presence” message to the Community Group Client application 308, i.e. it not only identifies entries in the contact list who subscribe to a Community Group service, but it also identifies the subscribed Community Group services, i.e., entry A has subscribed to PTT and Conferencing, B has subscribed to PTT only, C has subscribed to Conferencing only, etc. The user can then choose to include those contacts into one or more groups, thereby expanding their list of Community Group users.

Conclusion

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. An apparatus for providing advanced group services (AGS) in a cellular network, comprising:
a handset for communicating with the cellular network in order to provide the advanced group services;
wherein the cellular network includes at least one mobile switching center and at least one real-time exchange that interfaces to the mobile switching center, to provide the advanced group services therein, without requiring any changes to the mobile switching center or other equipment of the cellular network to provide the advanced group services;
wherein normal calls between the handset and other handsets are initiated by call setup and in-band signaling within the cellular network and voice frames for the calls are switched between the handset and the other handsets by the mobile switching center across bearer paths in the cellular network;
wherein the handset includes a client application that is downloaded from an online application store into the handset; and
wherein the client application is loaded onto the handset to communicate with the real-time exchange using the cellular network to provide the advanced group services on the handset.

2. The apparatus of claim 1, wherein the client application on the handset communicates with the real-time exchange using the cellular network to manage a subscription to the advanced group services.

3. The apparatus of claim 2, wherein the subscription is a “friends and family” subscription.

4. The apparatus of claim 3, wherein the client application on the handset communicates with the real-time exchange using the cellular network to perform family member modifications.

5. The apparatus of claim 1, wherein the client application on the handset performs ad hoc group creation for calling and messaging.

6. The apparatus of claim 1, wherein the client application on the handset communicates with the real-time exchange using the cellular network to synchronize with existing groups stored in the real-time exchange.

7. The apparatus of claim 1, wherein the client application on the handset performs group member modifications.

8. The apparatus of claim 1, wherein the client application on the handset communicates with the real-time exchange using the cellular network to provide information on other subscribers who are in a native phone book of the handset.

9. The apparatus of claim 1, wherein the client application on the handset performs an ad hoc quick reach function.

10. The apparatus of claim 1, wherein the client application on the handset performs a community identification to visually identify other subscribers in their contact list.

11. The apparatus of claim 1, wherein the client application on the handset performs a “friends and family” identification to visually locate “friends and family” members.

12. The apparatus of claim 1, wherein the client application on the handset performs a presence indication for other subscribers in a contact list of the client application.

13. The apparatus of claim 1, wherein the client application on the handset displays threaded group messaging showing message threading of messages to groups.

14. The apparatus of claim 1, wherein the messages comprise voice messages, messages with pictures, or messages with video.

15. The apparatus of claim 1, wherein the client application on the handset sends location information comprising a map of their location from a browser on the handset.

16. The apparatus of claim 1, wherein the client application on the handset performs chat services.

17. A method for providing advanced group services (AGS) in a cellular network, comprising:
communicating from a handset with the cellular network in order to provide the advanced group services;
wherein the cellular network includes at least one mobile switching center and at least one real-time exchange that interfaces to the mobile switching center, to provide the advanced group services therein, without requiring any changes to the mobile switching center or other equipment of the cellular network to provide the advanced group services;
wherein normal calls between the handset and other handsets are initiated by call setup and in-band signaling within the cellular network and voice frames for the calls are switched between the handset and the other handsets by the mobile switching center across bearer paths in the cellular network;
wherein the handset includes a client application that is downloaded from an online application store into the handset; and
wherein the client application is loaded onto the handset to communicate with the real-time exchange using the cellular network to provide the advanced group services on the handset.
